(19) United States
(12) Patent Application Publication
(10) Pub. No.: US 2016/0306246 A1
(43) Pub. Date: Oct. 20, 2016

(54) LIQUID CRYSTAL DISPLAY HAVING IMPROVED INVERSION AND MIXING CHARACTERISTICS

(71) Applicant: SAMSUNG DISPLAY CO., LTD., Yongin-si (KR)

(72) Inventors: Byung-Gon KUM, Suwon-si (KR); Sung Hwan WON, Suwon-si (KR); Ji Yeon CHOI, Yongin-si (KR); Sang Il KIM, Yongin-si (KR)

(21) Appl. No.: 15/097,202

(22) Filed: Apr. 12, 2016

(30) Foreign Application Priority Data
Apr. 15, 2015 (KR) 10-2015-0053367

(51) Int. Cl. G02F 1/1362; G02F 1/1343; G02F 1/1333; G02F 1/1368

(52) U.S. Cl. CPC G02F 1/136286; G02F 1/1368; G02F 1/13624; G02F 1/134309; G02F 1/133377; G02F 2001/134345

(57) ABSTRACT

A liquid crystal display includes a pixel electrode including a first subpixel electrode and a second subpixel electrode, a first common electrode corresponding to the first pixel electrode, a second common electrode corresponding to the second pixel electrode, a first transistor connected to the first subpixel electrode; a second transistor connected to the second subpixel electrode, a gate line connected to the first transistor and the second transistor, and a data line connected to the first transistor and the second transistor.

### CROSS-REFERENCE TO RELATED APPLICATION

This application claims priority to, and the benefit of, Korean Patent Application No. 10-2015-0053367 filed in the Korean Intellectual Property Office on Apr. 15, 2015, the entire contents of which are incorporated herein by reference.

### BACKGROUND

(a) Field

Embodiments of the present invention relate to a liquid crystal display.

(b) Description of the Related Art

A liquid crystal display, which is one of the most common types of flat panel displays currently in use, includes two sheets of display panels with field generating electrodes such as a pixel electrode and a common electrode, and a liquid crystal layer interposed therebetween. The liquid crystal display is driven by generating an electric field in the liquid crystal layer, which is accomplished by applying a voltage to the field generating electrodes, thus determining the direction of liquid crystal molecules of the liquid crystal layer by the generated electric field, and controlling polarization of incident light.

Further, the liquid crystal display includes a switching element connected to each pixel electrode, and a plurality of signal lines such as a gate line and a data line for applying a voltage to the pixel electrode by controlling the switching element.

Among the liquid crystal displays, a vertically aligned mode liquid crystal display, in which long axes of liquid crystal molecules are aligned to be vertical to the display panels in the absence of an electric field, has seen acceptance due to its high contrast and a wide reference viewing angle. Here, reference viewing angle refers to a viewing angle having a contrast ratio of 1:10 or a luminance inversion limit angle between grays.

In the case of the vertically aligned mode liquid crystal display, in order to accomplish side visibility that is approximately equal to front visibility, a method of varying transmittance by dividing one pixel into two or more subpixels and charging the subpixels with different voltages is proposed.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a liquid crystal display having improved visibility.

An exemplary embodiment of the present invention provides a liquid crystal display including: a pixel electrode including a first subpixel electrode and a second subpixel electrode; a first common electrode corresponding to the first pixel electrode; a second common electrode corresponding to the second pixel electrode; a first transistor connected to the first subpixel electrode; a second transistor connected to the second subpixel electrode; a gate line connected to the first transistor and the second transistor; and a data line connected to the first transistor and the second transistor.

The first subpixel electrode and the second subpixel electrode may be separated from each other.

The first subpixel electrode and the second subpixel electrode are applied with a same data voltage through the first transistor and the second transistor, respectively.

Each of the first and second transistors has a control terminal, an input terminal, and an output terminal. The control terminals of the first and second transistor may be connected to the gate line. The input terminals of the first and second transistor may be connected to the data line. The output terminal of the first transistor may be connected to the first subpixel electrode and the output terminal of the second transistor may be connected to the second subpixel electrode.

The first common electrode may overlap the first subpixel electrode. The second common electrode may overlap the second subpixel electrode.

The first common electrode and the second common electrode may be separated from each other. The first common electrode may be applied with a first common voltage and the second common electrode may be applied with a second common voltage that is different from the first common voltage.

The first common voltage and the second common voltage may have opposite phases.

The first common voltage and the second common voltage may swing between different levels.

The liquid crystal display may further include a liquid crystal layer disposed in a plurality of microcavities. The first pixel electrode and the first common electrode may overlap one of the plurality of microcavities. The second pixel electrode and the second common electrode may overlap another one of the plurality of microcavities.

The liquid crystal display may further include a roof layer disposed on the plurality of microcavities. The first common electrode and the second common electrode may be disposed between the plurality of microcavities and the roof layer.

According to an exemplary embodiment of the present invention, it is possible to improve visibility of the liquid crystal display.

### BRIEF DESCRIPTION OF THE DRAWINGS

FIG. 1 is a layout view of signal lines and pixels of a liquid crystal display according to an exemplary embodiment of the present invention.

FIG. 2 is a layout view of a part of the pixel of the liquid crystal display according to the exemplary embodiment of the present invention.

FIG. 3 is a cross-sectional view of the liquid crystal display of FIG. 2 taken along line III-III′.

FIG. 4 is an equivalent circuit diagram of one pixel of the liquid crystal display according to the exemplary embodiment of the present invention.

FIG. 5A illustrates common voltages that are applied to a liquid crystal display according to an exemplary embodiment, and FIG. 5B is a diagram illustrating an example of a pixel area ratio of a liquid crystal display when the common voltages according to FIG. 5A are applied to the liquid crystal display.

FIG. 6A is a diagram illustrating an example of data voltages that are applied to pixels of a liquid crystal display, and FIG. 6B is a diagram illustrating states of subpixels of the liquid crystal display according to FIG. 6A.

FIG. 7A illustrates common voltages that are applied to a liquid crystal display according to an exemplary embodiment, and FIG. 7B is a diagram illustrating another example of a pixel area ratio of a liquid crystal display when the common voltages according to FIG. 7A are applied to the liquid crystal display.

FIG. 8A is a diagram illustrating an example of data voltages that are applied to pixels of a liquid crystal display, and FIG. 8B is a diagram illustrating states of subpixels of the liquid crystal display according to FIG. 8A.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. The various figures are thus not to scale. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

All numerical values are approximate, and may vary. All examples of specific materials and compositions are to be taken as nonlimiting and exemplary only. Other suitable materials and compositions may be used instead.

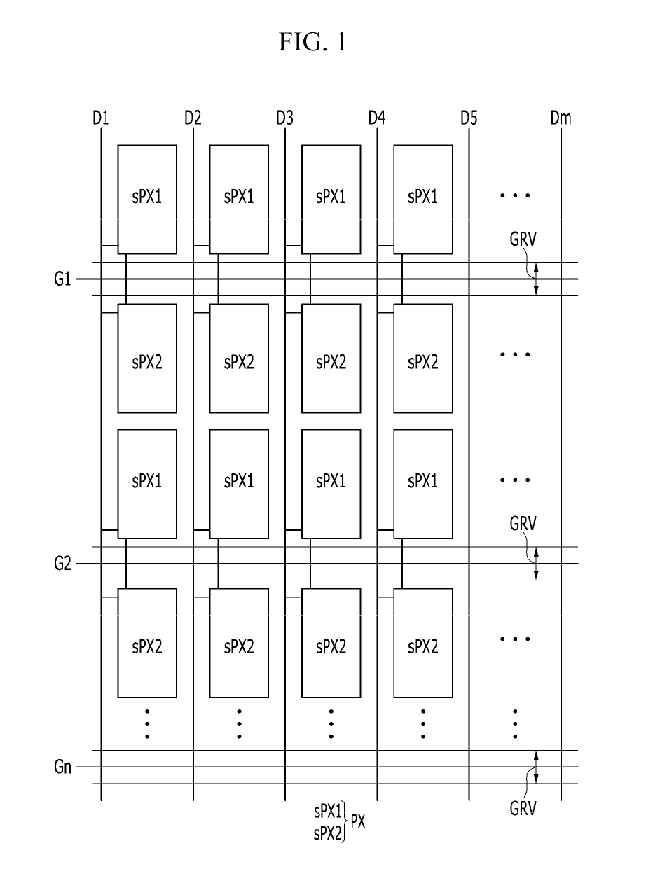

Hereinafter, a liquid crystal display according to an exemplary embodiment of the present invention will be described with reference to FIG. 1. FIG. 1 is a layout view of signal lines and pixels of a liquid crystal display according to an exemplary embodiment of the present invention.

Referring to FIG. 1, a liquid crystal display according to an exemplary embodiment of the present invention includes a plurality of gate lines G1, G2, . . . , and Gn which extend in a first direction, a plurality of data lines D1, D2, D3, D4, D5, . . . , and Dm which extend in a second direction, and a plurality of pixels PX connected to the gate lines and the data lines. Each pixel PX includes a first subpixel sPX1 and a second subpixel sPX2. Each of the gate lines G1, G2, . . . , and Gn is positioned between two subpixels sPX1 and sPX2.

In the liquid crystal display according to the exemplary embodiment of the present invention, grooves GRV are positioned between the subpixels sPX1 and sPX2. The grooves GRV extend in the first direction and overlap the gate lines G1, G2, . . . , and Gn.

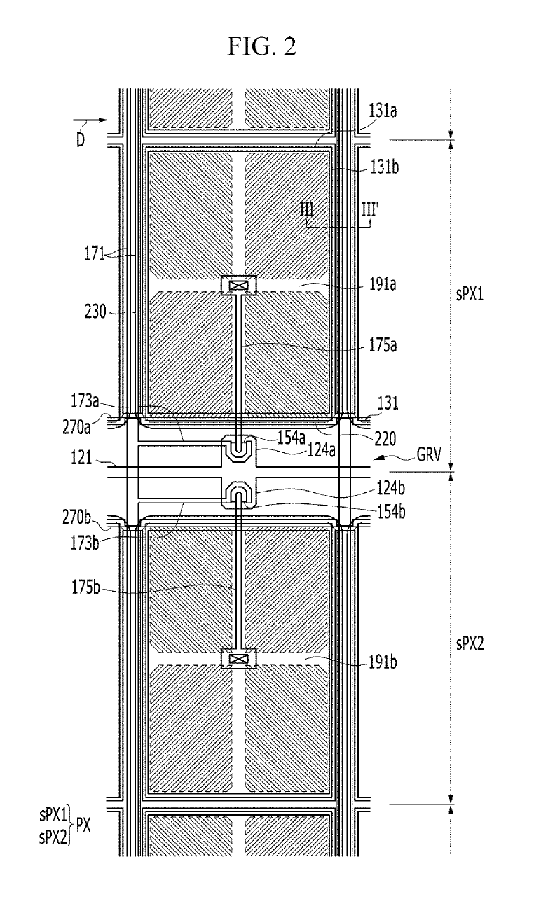

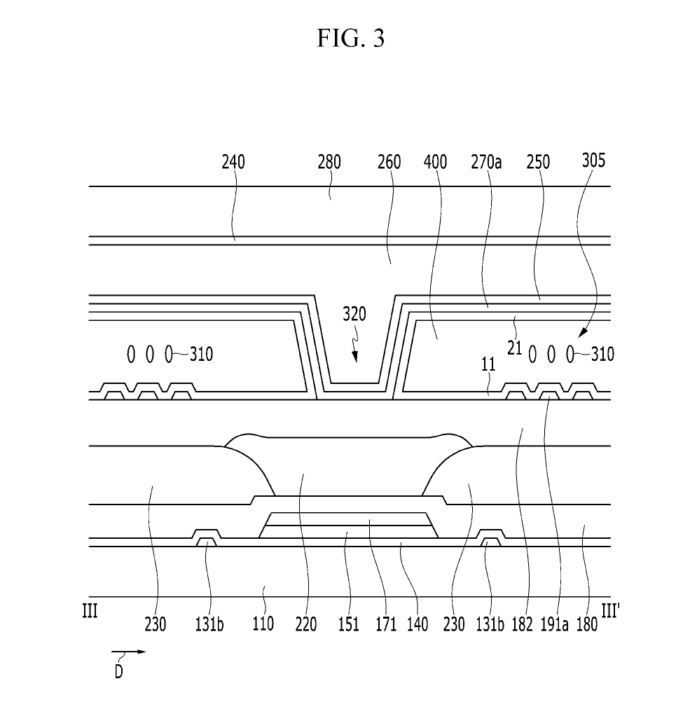

FIG. 2 is a layout view of a part of the pixel of the liquid crystal display according to the exemplary embodiment of the present invention, and FIG. 3 is a cross-sectional view of the liquid crystal display of FIG. 2 taken along line III-III′.

Referring to FIGS. 2 and 3, a gate line 121 and a storage electrode line 131 are positioned on a substrate 110 made of transparent glass, plastic, or the like. A pixel PX includes a first subpixel sPX1 and a second subpixel sPX2. The gate line 121 is positioned between the two subpixels sPX1 and sPX2.

The gate line 121 transfers a gate signal and mainly extends in a horizontal direction D. The gate line 121 includes a first gate electrode 124a and a second gate electrode 124b.

The storage electrode line 131 transfers a predetermined voltage such as a common voltage, and includes vertical portions 131b which extend to be substantially perpendicular to the gate line 121, and a horizontal portion 131a connecting ends of the vertical portions 131b to each other.

A gate insulating layer 140 is disposed on the gate line 131 and the storage electrode line 131. A semiconductor layer 151, a first semiconductor 154a and a second semiconductor 154b are disposed on the gate insulating layer 140, and a data line 171 is disposed on the semiconductor layer 151.

The data line 171 transfers a data voltage, and mainly extends in a vertical direction to cross the gate line 121. The data line 171 is connected to a first source electrode 173a which extends toward the first gate electrode 124a, and to a second source electrode 173b which extends toward the second gate electrode 124b. The first drain electrode 175a and the second drain electrode 175b are separated from the data line 171. The first drain electrode 175a faces the first source electrode 173a on the first gate electrode 124a, and the second drain electrode 175b faces the second source electrode 173b on the second gate electrode 124b.

In the illustrated exemplary embodiment, the first drain electrode 175a and the second drain electrode 175b include rod portions which extend substantially parallel with the data line 171. The drain electrodes 175a and 175b may have extending portions that are widened at ends of the rod portions of the drain electrodes 175a and 175b. The term “the rod portion” simply illustrates shapes of the drain electrodes 175a and 175b according to an exemplary embodiment, and the embodiments of the present invention are not limited to rod-shaped drain electrodes 175a and 175b. Any suitable shape is contemplated.

A first transistor is formed collectively by the first gate electrode 124a, the first source electrode 173a, the first drain electrode 175a, and the first semiconductor 154a. The first transistor is connected to a first subpixel electrode 191a of the first subpixel sPX1. Similarly, a second transistor is formed collectively by the second gate electrode 124b, the second source electrode 173b, the second drain electrode 175b, and the second semiconductor 154b. The second transistor is connected to a second subpixel electrode 191b of the second subpixel sPX2.

The semiconductor layers 151 and the first and second semiconductors 154a and 154b may have substantially the same shape in a plane view as the data line 171, the source and drain electrodes 173a, 173b, 175a, and 175b, and ohmic contacts (not illustrated) therebelow, except for channel regions between the source electrodes 173a and 173b and the drain electrodes 175a and 175b. This is, for example, the structure resulting when data conductors including the data line 171, the source electrodes 173a and 173b, and the drain electrodes 175a and 175b is simultaneously formed with ohmic contacts positioned therebelow and the semiconductor layer 151 and the first and second semiconductors 154a and 154b by using one mask. Parts of the semiconductors 154a and 154b between the source electrodes 173a and 173b and the drain electrodes 175a and 175b and not covered by them form channel regions of the first and second transistors.

A passivation layer 180 is formed on the data conductors 171, 173a, 173b, 175a, and 175b and the channel regions of the semiconductors. The passivation layer 180 may be made of an inorganic insulating material such as a silicon nitride and a silicon oxide. The passivation layer 180 may be made of an organic insulating material and a surface thereof may be substantially flat.

An organic layer 230 is positioned on the passivation layer 180. The organic layer 230 may not be present where the thin film transistors and the like are positioned. The organic layer 230 may be a color filter that may display one of primary colors such as red, green or blue. However, the color is not limited to the three primary colors of red, green and blue, and the color filter may display any other color such as one of cyan, magenta, yellow, and white-based colors.

The organic layers 230 which are adjacent to each other may be spaced apart from each other in the horizontal direction D and a vertical direction crossing the horizontal direction D. FIG. 3 illustrates organic layers 230 which are spaced apart from each other in the horizontal direction D.

A light blocking member 220 may be positioned on the organic layers 230 and an insulating layer 182 may be positioned on the light blocking member 220.

A pixel electrode 191 including the first and second subpixel electrodes 191a and 191b is positioned on the insulating layer 182. The first and second subpixel electrodes 191a and 191b are separated from each other (that is, they are not connected to each other), but may be applied with the same data voltage via the first and second transistors, respectively.

A lower alignment layer 11 is positioned on the pixel electrode 191 and an upper alignment layer 21 faces the lower alignment layer 11. A microcavity 305 is formed between the lower alignment layer 11 and the upper alignment layer 21. A liquid crystal layer including liquid crystal molecules 310 is positioned in the microcavity 305. The alignment material forming the alignment layers 11 and 21 and the liquid crystal material including the liquid crystal molecules 310 may be injected into the microcavity 305 by capillary force. To that end, the microcavity 305 may include an entrance (not illustrated) for injecting these materials. The lower alignment layer 11 and the upper alignment layer 21 may be connected to each other and may be simultaneously formed.

The display includes a plurality of microcavities 305 that are divided in the vertical direction by a groove GRV extending in the horizontal direction D. The display further includes a plurality of microcavities 305 that are divided in the horizontal direction D by a partition 320 extending in the vertical direction. Each of the microcavities 305 may correspond to one subpixel area or two or more subpixel areas.

A first common electrode 270a overlapping the first subpixel electrode 191a and a second common electrode 270b overlapping the second subpixel electrode 191b are positioned on the upper alignment layer 21. The first and second common electrodes 270a and 270b are separated from each other. The first and second common electrodes 270a and 270b may be applied with different common voltages.

The first and second common electrodes 270a and 270b generate electric fields together with the first and second subpixel electrodes 191a and 191b to which a data voltage is applied, to determine a degree at which the liquid crystal molecules 310 positioned in the microcavities 305 are tilted. Accordingly, the pixel electrode and the common electrodes are collectively referred to as field generating electrodes. The first and second common electrodes 270a and 270b are positioned above the microcavities 305, as illustrated in FIG. 3. In another embodiment, the first and second common electrodes 270a and 270b may be positioned below the microcavities 305.

The first common electrode 270a and the second common electrode 270b may be applied with different common voltages. In this case, a magnitude of the electric field generated by the first subpixel electrode 191a and the first common electrode 270a is different from that of the electric field generated by the second subpixel electrode 191b and the second common electrode 270b, although the same data voltage is applied to the first and second subpixel electrodes 191a and 191b. Accordingly, the tilt degree of the liquid crystal molecules 310 positioned between the first subpixel electrode 191a and the first common electrode 270a may be controlled differently from that of the liquid crystal molecules 310 positioned between the second subpixel electrode 191b and the second common electrode 270b. The first common electrode 270a and the first subpixel electrode 191a constitute a capacitor to maintain the applied voltage even after the first transistor is turned off. The second common electrode 270b and the second subpixel electrode 191b constitute a capacitor to maintain the applied voltage even after the second transistor is turned off.

A lower insulating layer 250 is positioned on the first and second common electrodes 270a and 270b. The lower insulating layer may be made of a silicon nitride or a silicon oxide. A roof layer 260 is positioned on the lower insulating layer 250. The roof layer 260 serves to support the microcavities 305 in which the liquid crystal layer is formed.

The roof layer 260 may include a photoresist or other organic materials. The roof layer 260 may also be formed by a color filter. The roof layer 260 may form the partition 320. The partition 320 is positioned between the microcavities 305 adjacent to each other in the horizontal direction D. The partition 320 may be formed along an extending direction of the data line 171 and may compart or define the microcavities 305. The roof layer 360 may include an inorganic material.

An upper insulating layer 240 is positioned on the roof layer 260. The upper insulating layer 240 may be made of a silicon nitride or a silicon oxide. A capping layer 280 is positioned on the upper insulating layer 240. The capping layer 240 may be positioned even in the groove GRV and may cover the entrance of the microcavity 305.

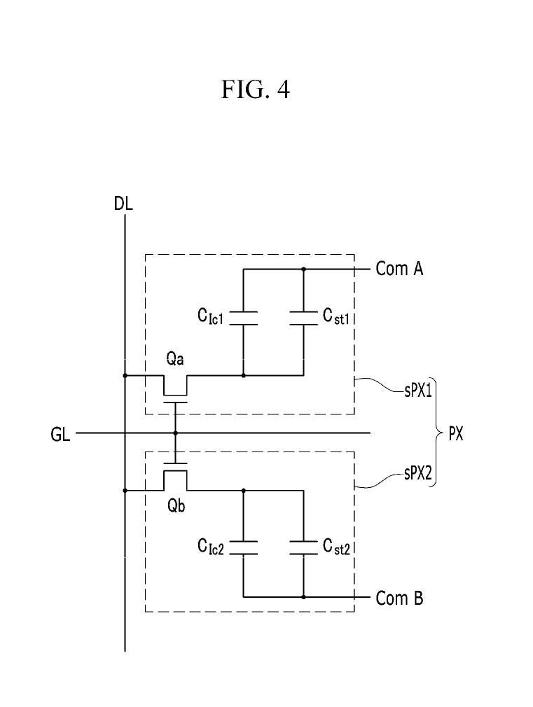

FIG. 4 is an equivalent circuit diagram of one pixel of the liquid crystal display according to the exemplary embodiment of the present invention.

Referring to FIG. 4, signal lines include a gate line GL transferring gate signals and a data line DL transferring data voltages. The gate line extends substantially in a row direction and the data line extends substantially in a column direction. The liquid crystal display includes a plurality of signal lines including a plurality of gate lines GL and a plurality of data lines DL, and a plurality of pixels PX connected to the plurality of signal lines.

In this case, each pixel PX includes a first subpixel sPX1 and a second subpixel sPX2. The first subpixel sPX1 includes a first liquid crystal capacitor C_{lc1} and a first storage capacitor Cₛₜ₁ that are connected to a first switching element Qa. The second subpixel sPX2 includes a second liquid crystal capacitor C_{lc2} and a second storage capacitor Cₛₜ₂ that are connected to a second switching element Qb. As previously described, the first subpixel sPX1 includes a first subpixel electrode and a first common electrode, and the second subpixel sPX2 includes a second subpixel electrode and a second common electrode.

Each of the first and second switching elements Qa and Qb, as a three-terminal element such as a transistor, is connected to the gate line GL (which can be one of G1, G2, . . . , Gn in FIG. 1) and the data line DL (which can be one of D1, D2, . . . , Dm in FIG. 1). In detail, control terminals of the first and second switching elements Qa and Qb are connected to the gate line GL, and input terminals thereof are connected to the data line DL. An output terminal of the first switching element Qa is connected to the first subpixel electrode that is one electrode of the first liquid crystal capacitor C_{lc1} and the first storage capacitor Cₛₜ₁. An output terminal of the second switching element Qb is connected to the second subpixel electrode that is one electrode of the second liquid crystal capacitor C_{lc1} and the second storage capacitor Cₛₜ₂. Accordingly, the first and second subpixels sPX1 and sPX2 may be applied with the same data voltage at the same time. However, the first and second subpixels sPX1 and sPX2 are applied with the same data voltage via the different switching elements Qa and Qb.

A first common voltage Com A is applied to the first common electrode of the first subpixel PXa, and is therefore applied to the first liquid crystal capacitor C_{lc1}. A second common voltage Com B is applied to the second common electrode of the second subpixel, and is therefore applied to the second liquid crystal capacitor C_{lc2}. The first and second common voltages Com A and Com B may swing between two levels. In an embodiment, a swing cycle may be one frame. The first and second common voltages Com A and Com B have opposite phases.

The first liquid crystal capacitor C_{lc1} is charged with a first pixel voltage by a difference between the data voltage applied through the first switching element Qa and the first common voltage Com A, and the second liquid crystal capacitor C_{lc22} is charged with a second pixel voltage by a difference between the data voltage applied through the second switching element Qb and the second common voltage Com B. Accordingly, the first and second subpixels sPXa and sPXb may provide different luminance for presenting a grayscale, thereby making side visibility be close to front visibility. A subpixel providing higher luminance may be referred to as a high subpixel and a subpixel providing lower luminance providing lower luminance may be referred to as a low subpixel.

In a case that the first and second subpixel electrodes are connected to each other and applied with a data voltage through one switching element, voltages of the first and second subpixel electrodes behave in the same manner when the first and second common voltages swing. As a result, in a middle portion of a liquid crystal display, high subpixels and low subpixels may be mixed in one frame, and in a lower portion of the liquid crystal display, the high subpixels and low subpixels may be reversed.

In the liquid crystal display according to the exemplary embodiment of the present invention, the first and second subpixel electrodes are not connected to each other although the first and second subpixel electrodes are applied with the same data voltage through the first and second switching elements, respectively. Accordingly, voltages of the first and second subpixel electrodes may vary separately when the first and second common voltages swing.

For example, when the first common voltage swings upward and the second common voltage swings downward, the voltage of the first subpixel electrode may increase and the voltage of the second subpixel electrode may decrease, due to a coupling effect. Likewise, when the first common voltage swings downward and the second common voltage swings upward, the voltage of the first subpixel electrode may decrease and the voltage of the second subpixel electrode may increase. Therefore, a charging state of the first liquid crystal capacitor C_{lc1} corresponding to the first pixel voltage may be substantially maintained in accordance with the swing of the first common voltage. Also, the second liquid crystal capacitor C_{lc2} corresponding to the second pixel voltage may be substantially maintained in accordance with the swing of the second common voltage. Accordingly, it is possible to prevent inversion and mixture of high and low subpixels that may be generated when the first and second subpixel electrodes are connected to one switching element.

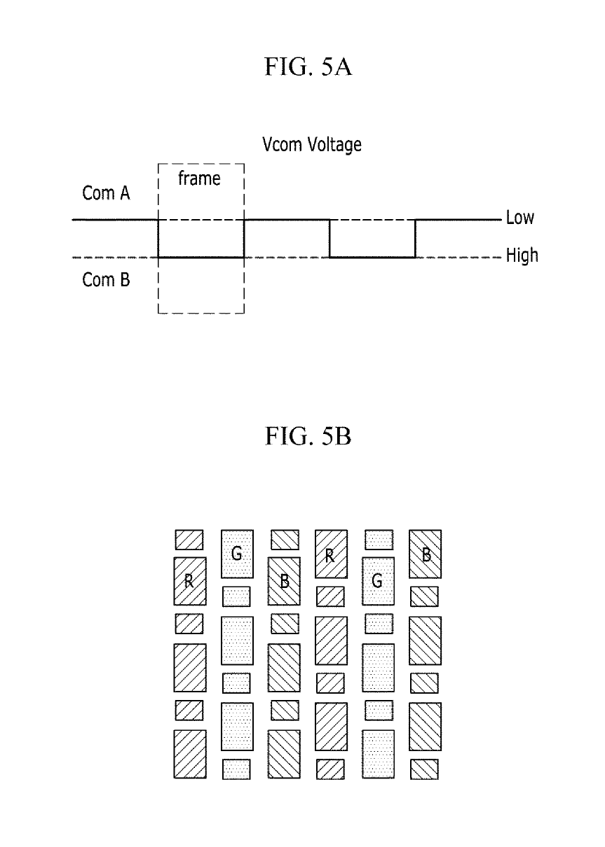

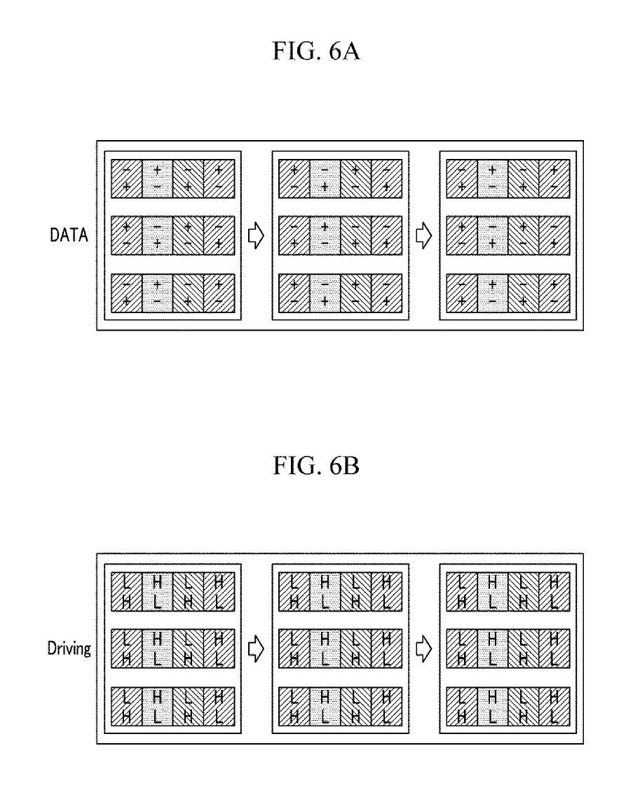

FIG. 5A illustrates common voltages that are applied to a liquid crystal display according to an exemplary embodiment, and FIG. 5B is a diagram illustrating an example of a pixel area ratio of a liquid crystal display when the common voltages according to FIG. 5A are applied to the liquid crystal display. FIG. 6A is a diagram illustrating an example of polarities of data voltages that are applied to pixels of a liquid crystal display, and FIG. 6B is a diagram illustrating states of subpixels of the liquid crystal display according to FIG. 6A.

Referring to FIG. 5A, the common voltages include a first common voltage Com A and a second common voltage Com B. The first common voltage Com A and the second common voltage Com B swing between a low level and a high level. For example, the first common voltage Com A may swing between 7 V and 8 V, and the second common voltage Com B may swing between 7 V and 8 V. In an embodiment, a swing cycle may be one frame. The first common voltage Com A and the second common voltage Com B have opposite phases. For example, while the first common voltage Com A is 7 V, the second common voltage Com B is 8 V, and while the first common voltage Com A is 8 V, the second common voltage Com B is 7 V.

A structure illustrated in FIG. 5B illustrates an example of a pixel area ratio according to applying of the first and second common voltages Com A and Com B to a first and second subpixels of each pixel, respectively, while applying the same data voltage to the first and second subpixels through first and second switching elements connected to same signal lines. Like FIG. 5A, in a condition where the first and second common voltages Com A and Com B are applied to the first and second subpixels in a bi-split com swing scheme, like FIG. 5B, a pixel area ratio for each subpixel may be controlled. A pixel area ratio illustrated in FIG. 5B is implemented in a form of 1:1 by applying the common voltages to the two subpixels of each pixel in a bi-split swing scheme.

Referring to FIG. 6A, a data voltage applied to each pixel has a positive (+) polarity or a negative (−) polarity. The positive (+) and negative (−) polarities of the data voltage are alternated over time, i.e. in a swing scheme. For example, the polarity of the data voltage may change by a frame unit and data voltages may be applied in a dot inversion driving method. In combination with the examples of FIGS. 5A and 5B where the first and second common voltages Com A and Com B are applied to the first and second subpixels of each pixel, respectively, the first and second subpixels of each pixel may be charged to different levels. Accordingly, one of the first and second subpixels may show higher luminance H and the other of the first and second subpixels may show lower luminance L, as illustrated FIG. 6B. Furthermore, one of the first and second subpixels may continuously show higher luminance H over consecutive frames and the other of the first and second subpixels may continuously show lower luminance L over the consecutive frames. In addition, a pixel area ratio of 1:1 illustrated in FIG. 5B may be implemented by adjusting data voltages applied to the pixels.

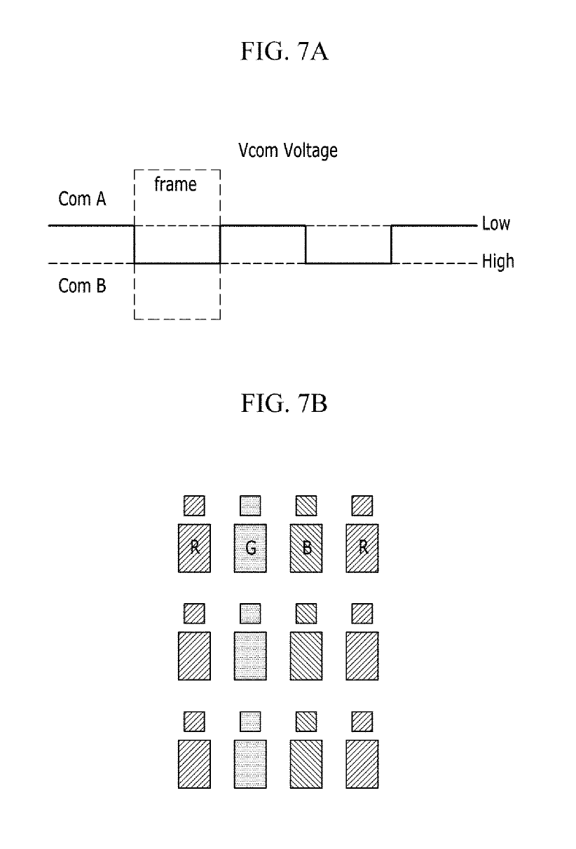

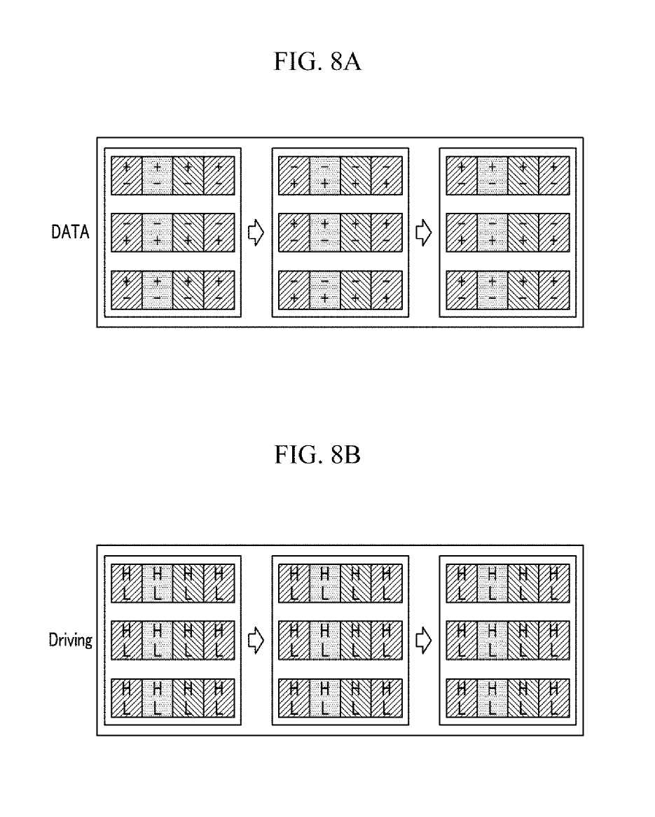

Next, FIG. 7A illustrates common voltages that are applied to a liquid crystal display according to an exemplary embodiment, and FIG. 7B is a diagram illustrating another example of a pixel area ratio of a liquid crystal display when the common voltages according to FIG. 7A are applied to the liquid crystal display. FIG. 8A is a diagram illustrating an example of data voltages that are applied to pixels of a liquid crystal display, and FIG. 8B is a diagram illustrating states of subpixels of the liquid crystal display according to FIG. 8A.

A structure illustrated in FIG. 7B illustrates an example in which a pixel area ratio of 1: X is implemented by applying a predetermined data voltage to a pair of subpixels of each pixel while a first common voltage Com A and a second common voltage Com B according to FIG. 7A are applied to the pair of subpixels.

Like FIG. 7A, in a condition where the first common voltage Corn A and the second common voltage Com B are applied to the pair of subpixels by a swing scheme, in FIG. 7B, a pixel area ratio for each subpixel may be controlled by adjusting a data voltage applying method. A pixel area ratio illustrated in FIG. 7B is implemented in a form of 1:X by maintaining a data voltage applied to the pair of subpixels through a pair of switching elements at a predetermined value.

Referring to FIG. 8A, data voltages are applied by a frame unit for each pixel, and the data voltages may be applied in a manner in which positive (+) and negative (−) polarities of the data voltages are maintained even though the frame elapses. That is, the data voltages may be applied in a line inversion driving method. In combination with the examples of FIGS. 7A and 7B where the first and second common voltages Com A and Com B are applied to the pair of subpixels respectively, the pair of subpixels may be charged with different levels. Accordingly, one of the subpixels may show higher luminance H and the other of the subpixels may show lower luminance L, as illustrated FIG. 8B. Furthermore, one of the subpixels may continuously show higher luminance H over consecutive frames and the other of the subpixels may continuously show lower luminance L over the consecutive frames. In addition, a pixel area ratio of 1:X may be implemented by adjusting data voltages applied to pixels.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Furthermore, different features of the various embodiments, disclosed or otherwise understood, can be mixed and matched in any manner to produce further embodiments within the scope of the invention.

What is claimed is:

1. A liquid crystal display, comprising:
a pixel electrode including a first subpixel electrode and a second subpixel electrode;
a first common electrode corresponding to the first pixel electrode;
a second common electrode corresponding to the second pixel electrode;
a first transistor connected to the first subpixel electrode;
a second transistor connected to the second subpixel electrode;
a gate line connected to the first transistor and the second transistor; and
a data line connected to the first transistor and the second transistor.

2. The liquid crystal display of claim 1, wherein:
the first subpixel electrode and the second subpixel electrode are separated from each other.

3. The liquid crystal display of claim 2, wherein:
the first subpixel electrode and the second subpixel electrode are applied with a same data voltage through the first transistor and the second transistor, respectively.

4. The liquid crystal display of claim 3, wherein:
each of the first and second transistors has a control terminal, an input terminal, and an output terminal, and
the control terminals of the first and second transistor are connected to the gate line, the input terminals of the first and second transistor are connected to the data line, the output terminal of the first transistor is connected to the first subpixel electrode, and the output terminal of the second transistor is connected to the second subpixel electrode.

5. The liquid crystal display of claim 1, wherein:
the first common electrode overlaps the first subpixel electrode, and
the second common electrode overlaps the second subpixel electrode.

6. The liquid crystal display of claim 5, wherein:
the first common electrode and the second common electrode are separated from each other,
the first common electrode is applied with a first common voltage, and
the second common electrode is applied with a second common voltage that is different from the first common voltage.

7. The liquid crystal display of claim 6, wherein:
the first common voltage and the second common voltage have opposite phases.

8. The liquid crystal display of claim 6, wherein:
the first common voltage and the second common voltage swing between different levels.

9. The liquid crystal display of claim 1, further comprising:
a liquid crystal layer disposed in a plurality of microcavities,
wherein the first pixel electrode and the first common electrode overlap one of the plurality of microcavities, and
the second pixel electrode and the second common electrode overlap another one of the plurality of microcavities.

10. The liquid crystal display of claim 9, further comprising:
a roof layer disposed on the plurality of microcavities,
wherein the first common electrode and the second common electrode are disposed between the plurality of microcavities and the roof layer.
